(19) United States
(12) Patent Application Publication
(10) Pub. No.: US 2004/0045415 A1
(43) Pub. Date: Mar. 11, 2004

(54) Switch member for a ratchet tool

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/237,742

(22) Filed: Sep. 10, 2002

(51) Int. Cl. B25B 13/46

(52) U.S. Cl. 81/63.2

(57) ABSTRACT

A ratchet tool includes a head and an engaging member is rotatably engaged with a hole in the head. A pawl of a ratchet mechanism is received in a recess defined in an inner periphery of the hole and is engaged with the toothed outer periphery of the engaging member. A switch member is functionally connected to the pawl and has a shift plate located at an outside of the head. The shift plate includes two inclined knurled surfaces defined in a surface thereof and each of the two inclined knurled surfaces has a direction indication plate connected thereto.

### FIELD OF THE INVENTION

The present invention relates to a switch member for a ratchet tool and includes two inclined knurled surfaces and each inclined knurled surface has a direction indication plate.

### BACKGROUND OF THE INVENTION

A conventional ratchet tool generally includes a head with a hole defined therethrough so as to receive an engaging member which has toothed outer periphery and a polygonal inner periphery which is to be engaged with an object such as a nut. A ratchet mechanism is received in the head and includes a pawl which has toothed surface for being matched with the toothed outer periphery of the engaging member. A switch member is connected to the pawl so as to switch the pawl to control the direction that the ratchet tool outputs a torque. The switch member is located at an outside of the tool so that the use may shift it by thumb. Nevertheless, the hand of the user is often attached with grease or oil that makes the friction between the switch and the thumb to be too small to shift the switch member.

The present invention intends to provide a switch member that includes two inclined knurled surfaces each of which has a direction indication plate so that the user can easily check the direction and shift it easily.

### SUMMARY OF THE INVENTION

In accordance with one aspect of the present invention, there is provided a ratchet tool which comprises a head with a hole defined therethrough for receiving an engaging member therein and a recess is defined in an inner periphery of the hole so as to receive a pawl which is engaged with the engaging member. A switch member is functionally connected to the pawl and has a shift plate located at an outside of the head. The shift plate includes two inclined knurled surfaces defined in a surface thereof.

The primary object of the present invention is to provide a switch member that has two inclined knurled surfaces for convenience of shifting by the user.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet tool of the present invention;

FIG. 2 is an exploded view to show the ratchet tool of the present invention;

FIG. 3 shows the switch member is shifted to the left and the right, and

FIG. 4 shows another embodiment of the direction indication plates.

### DETAILED DESCRIPTION OF THE PREFERRED EMBODIMENT

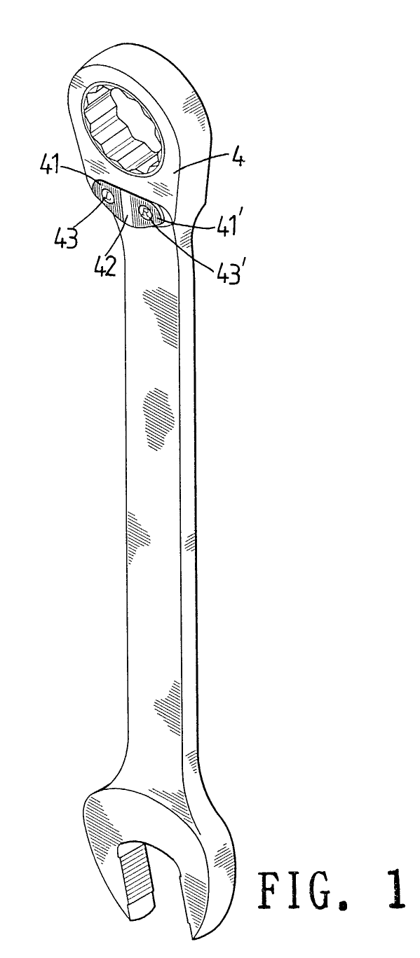

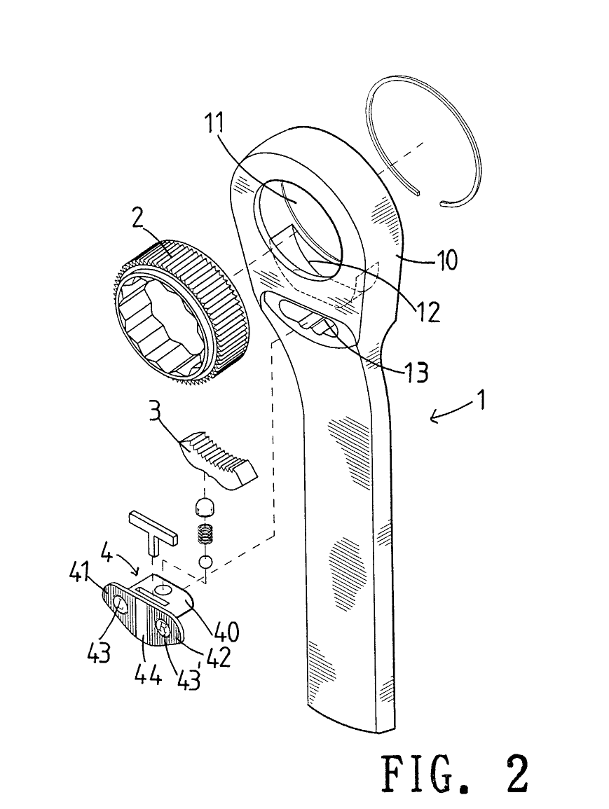

Referring to FIGS. 1 to 3, the ratchet tool 1 of the present invention comprises a head 10 with a hole 11 defined therethrough and a recess 12 is defined in an inner periphery of the hole 11. An engaging member 2 is rotatably engaged with the hole 11 in the head 10 and has a toothed outer periphery and a polygonal inner periphery. A slot 13 is defined in the head 10 and in communication between the recess 12 and the outside of the head 10.

A pawl 3 is received in the recess 12 and has a toothed surface defined in a first side thereof, the toothed surface matched with the toothed outer periphery of the engaging member 2.

A switch member 4 functionally connected to the pawl 3 and includes an insertion 40 which is movably inserted in the slot 13. A bead and a spring are received in a notch defined in the insertion 40 and the bead is urged against a second side of the pawl 3. A shift plate is connected to the insertion 40 and can be accessed from an outside of the head 10. The shift plate includes two inclined knurled surfaces 41, 42 defined in a surface thereof. Each of the two inclined knurled surfaces 41, 42 has a direction indication plate 43, 43′ connected thereto. A blank portion 44 is defined in the shift plate and located between the two inclined knurled surfaces 41, 42.

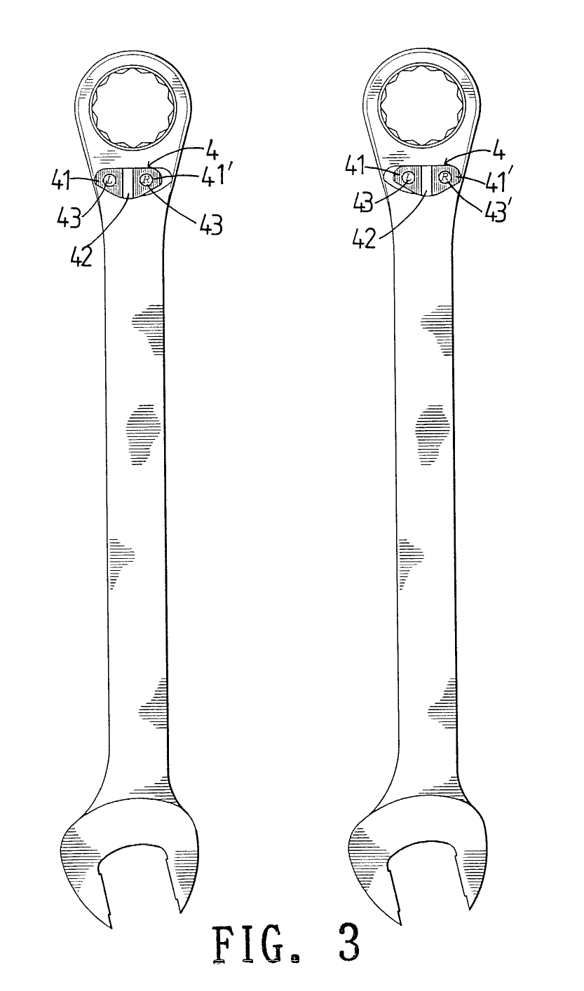

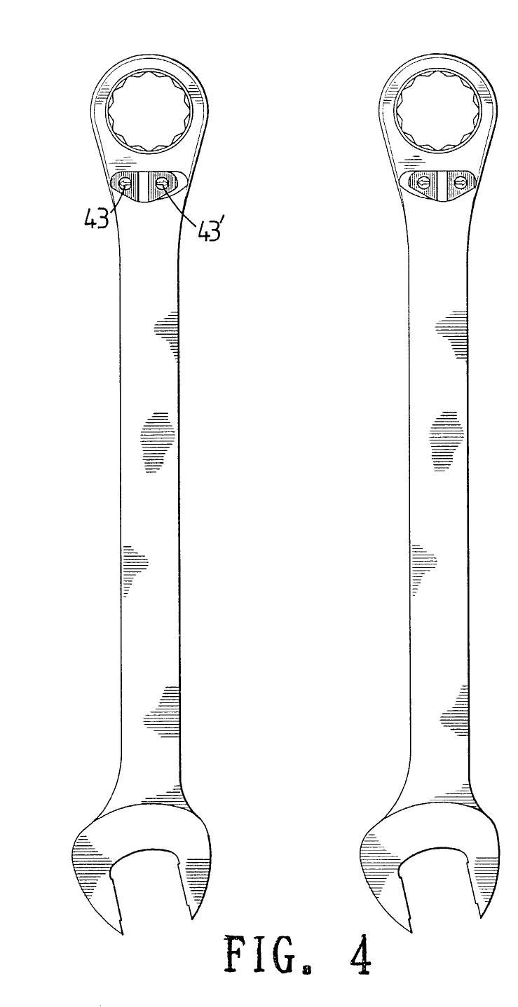

The user can see the direction indication plate 43, 43′ to know which direction is to be operated and the two inclined knurled surfaces 41, 42 allow the user to easily push the shift plate. The direction indication plate 43, 43′ can be marked with “R” and “L” to show the direction as shown in FIG. 3. The direction indication plate 43, 43′ can also be marked with arrow heads to show the direction as shown in FIG. 4.

While we have shown and described the embodiment in accordance with the present invention, it should be clear to those skilled in the art that further embodiments may be made without departing from the scope of the present invention.

What is claimed is:

1. A ratchet tool comprising:
a head with a hole defined therethrough and a recess defined in an inner periphery of the hole;
an engaging member rotatably engaged with the hole in the head and having a toothed outer periphery and a polygonal inner periphery;
a pawl received in the recess and having a toothed surface defined in a first side thereof, the toothed surface matched with the toothed outer periphery of the engaging member, and
a switch member functionally connected to the pawl and having a shift plate located at an outside of the head, the shift plate including two inclined knurled surfaces defined in a surface thereof.

2. The ratchet tool as claimed in claim 1, wherein each of the two inclined knurled surfaces has a direction indication plate connected thereto.

3. The ratchet tool as claimed in claim 1, wherein a slot is defined in the head and in communication between the recess and the outside of the head, the switch member including an insertion movably inserted in the slot and the shift plate connected to the insertion, a bead and a spring received in a notch defined in the insertion and the bead being urged against a second side of the pawl.
